(19) United States
(12) Patent Application Publication
(10) Pub. No.: US 2025/0136451 A1
(43) Pub. Date: May 1, 2025

(54) MXENE MATERIALS WITH ENHANCED STABILITY

(71) Applicant: DREXEL UNIVERSITY, Philadelphia, PA (US)

(72) Inventors: Yury GOGOTSI, Warminster, PA (US); Armin VAHIDMOHAMMADI, Horsham, PA (US); Kyle MATTHEWS, Philadelphia, PA (US); Teng ZHANG, Philadelphia, PA (US)

(21) Appl. No.: 18/682,547

(22) PCT Filed: Aug. 10, 2022
(86) PCT No.: PCT/US2022/074772

§ 371 Date: Feb. 9, 2024

Related U.S. Application Data
(60) Provisional application No. 63/231,333, filed on Aug. 10, 2021.

(51) Int. Cl. C01B 32/914

(52) U.S. Cl. CPC C01B 32/914; C01P 2002/72; C01P 2002/84; C01P 2002/88; C01P 2004/03; C01P 2006/22; C01P 2006/40

(57) ABSTRACT

Provided is a method, comprising: providing a solution of delaminated MXene material and a first ionic intercalant; and contacting the solution with a second ionic intercalant so as to exchange the first ionic intercalant and the second ionic intercalant so as to give rise to flocculated portions of the MXene material and a supernatant that comprises the first ionic intercalant and the second ionic intercalant. Also provided is a MXene dispersion, comprising a plurality of portions of single-layer and/or few-layer MXene dispersed in a solvent, the solvent comprising a first ionic intercalant and a second ionic intercalant. Also provided is a stable MXene dispersion, comprising a plurality of portions of single-layer and/or few-layer MXene dispersed in a solvent, the solvent comprising an ionic intercalant, the ionic intercalant optionally being present in supersaturated form.

### CROSS-REFERENCE TO RELATED APPLICATIONS

The present application claims priority to and the benefit of U.S. patent application No. 63/231,333, “MXene Materials With Enhanced Stability” (filed Aug. 10, 2021), the entirety of which application is incorporated herein by reference for any and all purposes.

### GOVERNMENT RIGHTS

This invention was made with government support by the Fluid Interface Reactions, Structures and Transport (FIRST) Center, an Energy Frontier Research Center (EFRC) funded by the U.S. Department of Energy, Office of Science, Office of Basic Energy Sciences. The government has certain rights in the invention.

### TECHNICAL FIELD

The present disclosure relates to the field of MXene materials.

### BACKGROUND

Vanadium carbide MXenes, e.g., V₂CTₓ, have shown promise for applications ranging from energy storage and sensing, to electronics and optics. In the past decade, however, research involving V₂CTₓ has been limited to the material's multilayered form because of the instability of delaminated V₂CTₓ in the material's colloidal state. Accordingly, there is a need in the art for stabilized forms of MXenes, including vanadium carbide MXenes.

### SUMMARY

In meeting the described long-felt needs, the present disclosure provides methods, comprising: providing a solution of delaminated MXene material and a first ionic intercalant; and contacting the solution with a second ionic intercalant so as to exchange the first ionic intercalant and the second ionic intercalant so as to give rise to flocculated portions of the MXene material and a supernatant that comprises the first ionic intercalant and the second ionic intercalant.

Also provided are MXene dispersions, comprising a plurality of portions of single-layer and/or few-layer MXene dispersed in a solvent, the solvent comprising a first ionic intercalant and a second ionic intercalant.

Further provided are stable MXene dispersions, comprising a plurality of portions of single-layer and/or few-layer MXene dispersed in a solvent, the solvent comprising an ionic intercalant, the ionic intercalant optionally being present in supersaturated form.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1F. (FIG. 1A) Schematic of MXene synthesis process. (FIG. 1B) XRD patterns of V₂AlC MAX and multilayer V₂CTₓ made by HF etching and mixed acid synthesis methods. (FIG. 1C) Optical image of first supernatant (green) after washing. SEM images of the (FIG. 1D) V₂AlC MAX phase, (FIG. 1E) multilayer V₂CTₓ from HF etching, and (FIG. 1F) multilayer V₂CTₓ from mixed acid etching.

FIGS. 2A-2E. (FIG. 2A) Delaminated d-V₂CTₓ solution (diluted). SEM images of TBA-V₂CTₓ flakes from (FIG. 2B) HF etching and (FIG. 2C) HF/HCl etching on anodized aluminum oxide (AAO). (FIG. 2D) DLS measurements and (FIG. 2E) UV-vis measurements for TBA-V₂CTₓ (HF and HF/HCl etch) and TMA-V₂CTₓ.

FIGS. 3A-3D. Optical images of vacuum filtered films made from (FIG. 3A) TBA-V₂CTₓ (HF etched) and (FIG. 3B) TMA-V₂CTₓ (HF/HCl etched). (FIG. 3C) SEM image of cross-section from the TMA-V₂CTₓ vacuum filtered film. (FIG. 3D) XRD patterns of TBA-V₂CTₓ (HF and HF/HCl) and TMA-V₂CTₓ (HF/HCl etch).

FIGS. 4A-4E. (FIG. 4A) UV-vis spectra of HF etched TBA-V₂CTₓ and oxidized V₂CTₓ solution. (FIG. 4B) UV-vis spectra of pristine HF/HCl TBA-V₂CTₓ collected at 1 h intervals to show oxidation. TMA-V₂CTₓ (HF/HCl etched) films (FIG. 4C) from pristine solution, (FIG. 4D) from 1 month old solution (stored in an argon filled vial), and (FIG. 4E) from pristine solution aged in air for 1 month after drying.

FIGS. 5A-5D. (FIG. 5A) Schematic of the ion-exchange procedure. (FIG. 5B) d-V₂CTₓ solution flocculated using LiCl. (FL. 5C) XRD patterns of TBA-V₂CTₓ, TMA-V₂CTₓ, and Li—V₂CTₓ made from both samples. These samples were all vacuum-filtered films from the mixed acid synthesis (the TMA and TBA-V₂CTₓ patterns are taken from FIG. 3D). (FIG. 5D) Conductivity measurements from vacuum filtered V₂CTₓ films with different interlayer ions (TBA⁺, TMA⁺, Li⁺). Inset image of vacuum filtered Li-V₂CTₓ (TBA) shown. from vacuum filtered V₂CTₓ films with different interlayer ions (TBA⁺, TMA⁺, Li⁺).

FIGS. 6A-6D. UV-vis spectra of (FIG. 6Aa) HF etched V₂CTₓ and HF/HCl etched V₂CTₓ kept flocculated over different periods of time. (FIG. 6B) Concentrated and (FIG. 6C) dilute Li-V₂CTₓ solution redispersed after 147 days. (FIG. 6D) Vacuum filtered Li-V₂CTₓ film made from 147 day old solution.

FIGS. 7A-7E. Digital photographs of (FIG. 7A) a large volume of TMA-V₂CTₓ solution, (FIG. 7B) a flocculated Li-V₂CTₓ solution, (FIG. 7C) a Li-V₂CTₓ aerogel, (FIG. 7D) Li-V₂CTₓ/PVA hydrogels of increasing MXene concentration (logo credited to Drexel University, College of Engineering), and (FIG. 7E) a Li-V₂CTₓ solution spray coated on glass with increasing thickness.

FIG. 8. Map of etching and delamination procedures performed to arrive at mixed acid etch used in this main text.

FIGS. 9A-9E. Optical Images of: (FIG. 9A) ice bath setup used for etching V₂AlC, (FIG. 9B) V₂AlC MAX phase, (FIG. 9C) ml-V₂CTₓ synthesized from HF etching. Pressed pellets of multilayer V₂CTₓ from (FIG. 9D) HF etching and (FIG. 9E) mixed acid (HF/HCl) etching.

FIGS. 10A-10E. (FIG. 10A) XRD patterns of different V₂AlC MAX phase powders (the “Conventional MAX” pattern is taken from the main text, panel e of FIG. 1); (FIG. 10B) UV-Vis measurements showing the stability of Li-V₂CTₓ (HF/HCl etch, TBA⁺ delaminated) from different MAX phase precursors (the “Conventional MAX” spectra was taken from FIG. 5B); SEM images of (FIG. 10C) MAX phase synthesized from traditional conditions outlined in the main text; (FIG. 10D) MAX phase obtained from Carbon Ukraine, Ltd. (FIG. 10E) MAX phase synthesized using an excess (1.6× more than traditional synthesis) of aluminum during synthesis. This concept is based on prior experiments with Ti₃C₂Tₓ.¹

FIG. 11. UV-Vis Spectra of TBA-V₂CTₓ etched using the HF method. The sample was kept in the spectrophotometer and spectra were collected at 1-hour intervals.

FIG. 12. Zeta potential measurements for TMA- and TBA-V₂CTₓ, synthesized using the mixed acid etch. These graphs are averages of 5 collected intensity distributions.

FIGS. 13A-13E. Thermogravimetric analysis in an Ar atmosphere of (FIG. 13A) ml-V₂CTₓ powder, d-V₂CTₓ films synthesized from (FIG. 13B) TBAOH, (FIG. 13C) TMAOH, and Li—V₂CTₓ films synthesized from (FIG. 13D) TBAOH and (FIG. 13E) TMAOH.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

Vanadium carbide MXenes, specifically V₂CTₓ, have shown promise for applications ranging from energy storage and sensing, to electronics and optics. In the past decade, however, research involving V₂CTₓ has been mostly limited to its multilayered form due to instability of delaminated V₂CTₓ in its colloidal state.

Provided here is, inter alia, a mild synthesis condition approach that results in high-quality MXenes (e.g., V₂CTₓ) and an ion exchange process coupled with flocculation that increases the shelf life of the MXene (e.g., in aqueous suspension) by about three orders of magnitude, from a few hours to several months. Without being bound to any particular theory or embodiment, we explain the effect of etchant formulation, delamination chemicals, and post-processing on the quality, chemical stability, and optoelectronic properties of the synthesized MXene.

As an illustration of the disclosed technology, we demonstrate that V₂CTₓ produced using ion-exchange to replace tetrabutylammonium or tetramethylammonium ions with lithium cations and flocculation after delamination can not only be stored in suspension for a few months without degradation, but also can be redispersed and processed into films. Those MXene films show distinct improvements in the optical and electronic properties. Their electrical conductivities in dry state can exceed 1,000 S cm¹, a value not previously achievable for V₂CTₓ. The improvements in shelf life and properties of V₂CTₓ demonstrated in this work allow fundamental studies of properties of this and other MXenes and greatly expand the range of MXenes applications. The described approach is applicable to other MXenes, e.g., those for which one can use quaternary amines for delamination.

Since their discovery in 2011,¹ two-dimensional (2D) transition metal carbides and nitrides, MXenes, have shown promising electrical,² mechanical,³ optical,⁴ and electrochemical properties leading to their widespread use in applications such as energy storage,⁵ electromagnetic interference shielding,^{6,7} sensing,^{8,9} electronics,^{10,11} and biomedicine,¹²⁻¹⁴ to name a few examples.

MXenes have a general formula of Mₙ₊₁XₙTₓ, where M represents early transition metals (Ti, V, Nb, etc.), X is carbon and/or nitrogen, n=1-4, and Tₓ represents the surface functional groups (—O, —OH, —F, —Cl) on these materials.¹⁵ The possibility of having different single or double transition metals, in an ordered or solid solution (random) form, on the M site along with C and/or N in the X site, has resulted in the experimental synthesis of more than 30 stoichiometric MXene compositions with many more computationally predicted.¹⁶ However, despite the numerous MXene compositions available, research has primarily focused on Ti₃C₂Tₓ, mainly because of its high chemical stability and the presence of established synthesis guidelines.

Among other MXenes, the M₂XTₓ structure, in particular V₂CTₓ, is interesting due to its larger active area per mass (lower number of atomic layers in their structure; 3 atomic-layers for V₂C vs 5 atomic-layers for Ti₃C₂) with a more chemically active transition metal (vanadium) that has multiple oxidation states. Multilayer (ml-V₂CTₓ) or delaminated films of V₂CTₓ (d-V₂CTₓ) have been used in various applications such as batteries, ^{17,18} supercapacitors,¹⁹ gas sensors,²⁰ electronics,²¹ optics,²² and bio-medicine.¹⁴ Similar to other MXenes, density functional theory calculations (DFT) have suggested that bare and F/OH terminated V₂C should show metallic behavior,²³ however, because of the presence of large organic intercalants (used for delamination) in the interlayer space of V₂CTₓ flakes, experimental measurements have shown semiconductor-like electronic behavior and a negative temperature-dependent resistivity change for V₂CTₓ multilayer films.²⁴ The unusual electronic properties of d-V₂CTₓ have rendered it promising for various optoelectronic applications. For example, transparent conductive electrodes made from spin-coated thin films of V₂CTₓ have shown a higher figure of merit (FOM) compared to other M₂XTₓ MXenes, such as Ti₂CTₓ.²¹

V₂CTₓ is anecdotally known to be the least chemically stable MXene in its delaminated form. Single and few-layer V₂CTₓ flakes readily degrade in water dispersions or when exposed to air. Because of this instability, previous studies have mostly focused on ml-V₂CTₓ rather than d-V₂CTₓ.²⁵ In addition, V₂CTₓ is commonly delaminated by large organic molecules such as tetramethylammonium hydroxide (TMAOH) or tetrabutylammonium hydroxide (TBAOH). Because complete removal of TBA⁺ or TMA⁺ ions is difficult to achieve, produced V₂CTₓ films usually show a large interlayer spacing. This, along with highly defective nature of V₂CTₓ flakes^{17,19} as well as its other intrinsic properties, have so far resulted in lower electrical conductivities (140 S cm⁻¹) compared to Ti₃C₂Tₓ.^{21,26,27}

To overcome the chemical instability of V₂CTₓ (and other less stable MXenes, such as Ti₂CTₓ), numerous post processing approaches including the addition of polyanionic salts to hinder edge-driven oxidation, adjustment of the colloidal solution pH with buffers, and antioxidants have been attempted.^{28,29} Although these approaches lead to improved MXene chemical stability in water dispersions, they can negatively affect the electronic and electrochemical properties. Using buffers in the solution, whether acidic or basic, decreases the electrical conductivity of vacuum filtered films. Moreover, the use of alkaline buffers led to faster MXene degradation over time.²⁹ In addition to post-processing treatments, the quality of the MAX phase precursor, and initial etching and delamination conditions are also important factors for the synthesis of higher quality and chemically stable V₂CTₓ flakes, which has already been shown for Ti₃C₂Tₓ.^{27,30} Therefore, to practically use V₂CTₓ for research purposes or device applications, after confirming proper stoichiometry and particle size of the V₂AlC MAX phase precursor, first, the etching and delamination conditions should be improved to produce higher quality V₂CTₓ flakes. Second, proper protocols should be developed to improve its chemical stability without negatively affecting its properties. The combination of these two improvements will alleviate existing challenges facing the community, enabling more widespread use of V₂CTₓ.

In this disclosure, we discuss the improved etching and delamination protocols for the synthesis of V₂CTₓ and show that, through an ion exchange approach couple with flocculation, d-V₂CTₓ flakes can be stored for several months with no significant degradation occurring even after −150 days. We use a mixed acid etchant formulation to synthesize ml-V₂CTₓ, followed by delamination with TBAOH or TMAOH. A LiCl ion-exchange/flocculation process is used as a post-processing technique to stabilize the d-V₂CTₓ flakes. This approach both improves its chemical stability and nearly doubles the electrical conductivity of V₂CTₓ freestanding films. We attribute these enhancements to the replacement of the TBA⁺ or TMA⁺ with Li⁺ ions, indicated by a significant reduction in the d-spacing of the MXene films, and their increased conductivity above 1,000 S cm¹. It should be understood, however, that although the disclosed technology is illustrated by non-limiting application to V₂CTₓ, the disclosed technology is applicable to MXenes in general and is not limited to V₂CTₓ.

### Discussion of Methods

### Precursor and Etching Conditions

Research on Ti₃C₂Tₓ has shown that properties and morphology of the prepared MXene depend on the stoichiometry, quality, and particle size of the MAX phase precursor.¹⁵ For example, it was recently shown that increasing Ti₃AlC₂ MAX phase quality by controlling its stoichiometry leads to less defective Ti₃C₂Tₓ flakes with enhanced chemical stability.³⁰ Similarly, the successful synthesis of high quality V₂CTₓ depends on the stoichiometry and quality of the V₂AlC MAX phase precursor. For the synthesis of V₂AlC, vanadium (99.5%, −325 mesh), aluminum (99.5%, −325 mesh), and graphite (99%, −325 mesh) powders are used.

First, V, Al, and C precursors are mixed in a 2:1.1:0.9 atomic ratio (e.g., 50 g total per batch). The precursors are ball-milled with 10 mm yttria stabilized zirconia balls (2:1 ball: powder mass ratio) in plastic jars at 60 rpm for 18 h to ensure a homogeneous mixture of the powders. The powder mixture is transferred into alumina crucibles and placed into a high-temperature tube furnace (Carbolite Gero). The furnace should be purged with ultra-high purity Ar gas (200 SCCM) prior to heating for at least 1 hour. Argon should also be continually flown through the furnace throughout the sintering procedure. The furnace is heated to 1550° C. at a rate of 3° C. min⁻¹, held for 2 h, and then cooled to room temperature at a rate of 3° C. min⁻¹. Afterwards, the sintered compact can be milled using a TiN-coated bit or crushed with a mortar and pestle, then sieved to the desired particle size (usually <38 μm (400 mesh)). The sieving process ensures a uniform particle size distribution and similar etching kinetics between the MAX particles. The obtained V₂AlC particles usually contain unreacted elemental powders or intermetallic impurities. They can be removed by acid washing the MAX powders in 9 M HCl for 12 hours. 2 mL of 9 M HCl were used for every gram of V₂AlC. Afterwards, the V₂AlC particles are washed by filtration with deionized water until a pH of >5-5.5 is achieved.

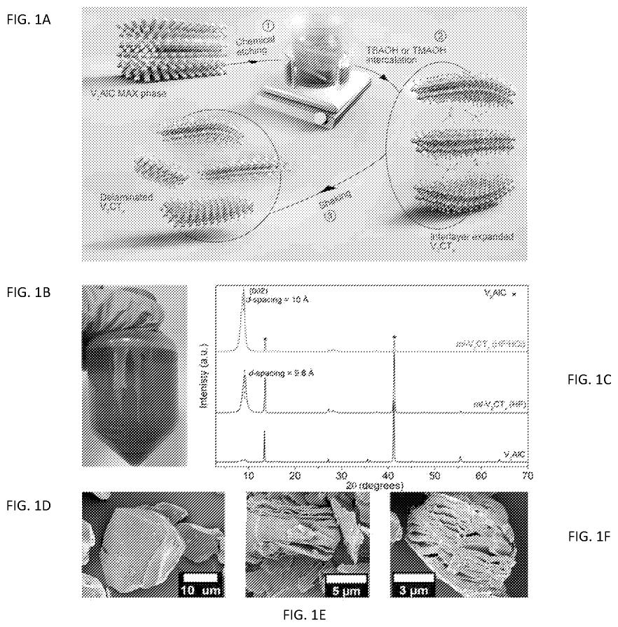

FIG. 1A shows different steps involved for the synthesis of V₂CTₓ. Typically, V₂AlC is etched in 48-50% hydrofluoric acid (HF). To address certain challenges associated with using concentrated HF, we developed a milder etchant based on a mixture of HF and hydrochloric acid (HCl) for the synthesis of V₂CTₓ, the details of which is provided in the following text.

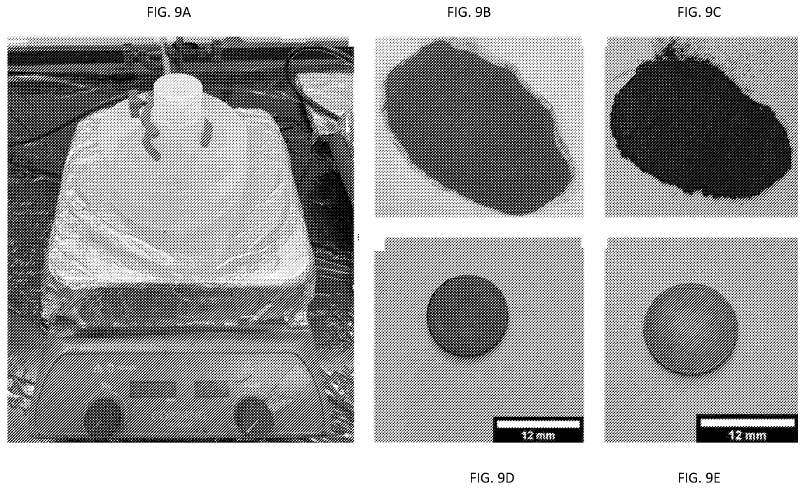

Etching can be done in high density polyethylene (HDPE) bottles and per 1 g of V₂AlC, 20 mL of etching solution (either pure HF or HF/HCl as described below) was used. To ensure safety and proper mixing, the etching bottle can be selected so that the etchant does not occupy more than one third of its volume. For example, 1 g V₂AlC can be etched in a 60 mL HDPE bottle, but if 2 g V₂AlC powder is required to be etched, the volume of etchant solution will be 40 mL and therefore, a larger HDPE bottle (i.e. 125 mL) should be used. Moreover, it is useful to use an ice bath for the addition of V₂AlC because the highly reactive particles can experience local heating (as the result of exothermic reaction between MAX phase powder and the acidic etchant) which can cause instant oxidation/dissolution. Therefore, after placing the etchant bottle in an ice bath (FIG. 9a), slowly, 1 g of V₂AlC is added to the etchant while stirring the solution at low speed (150 rpm). The addition of powder can take appx. 5 min per gram of MAX phase.

After all powder is added, one can monitor the reaction for 1-2 min to make sure no severe reaction is occurring (no bubbling should be observed). Then the bottle is loosely capped, and subsequently transferred to an oil bath to start the etching in a controlled temperature condition. Stirring speed can be fixed at 400 rpm for all etching conditions. The proper safety precautions should be followed when working with HF, as recently outlined.³²

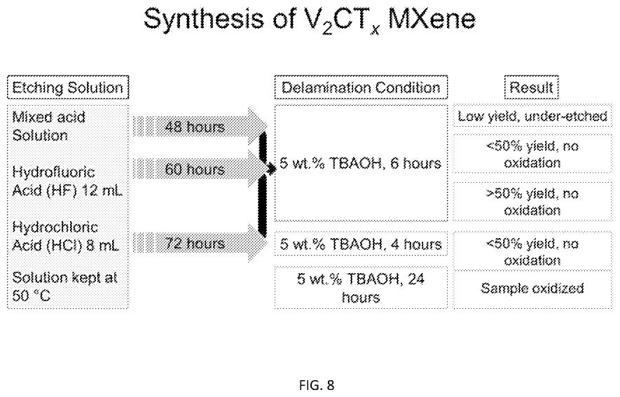

We investigated the effect of etching time of V₂AlC in HF and HF/HCl solutions and determined the minimal time required for most complete conversion of V₂AlC into V₂CTₓ without inherent oxidation. The table in FIG. 8 outlines the different etching configurations tested. The premise of a mixed acid etch was based on previous work with Ti₃C₂Tₓ.³³ For the conventional HF etching protocol, 20 mL of 48 wt. % HF is used per 1 g of MAX phase, and the reaction proceeds for 96 hours at 25° C.¹⁸ For the mixed acid method, 1 g of V₂AlC is added to a mixture of 12 mL of 48 wt. % HF and 8 mL of 12 M HCl, and the reaction proceeds for 72 hours at 50° C.

After etching is completed, the etchant mixture is diluted and transferred to 175 mL centrifuge tubes and centrifuged at 3500 rpm (2550 rcf) for 5 minutes. At this point, the ml-V₂CTₓ, along with any remaining MAX phase, will be sedimented at the bottom of the tube and a green supernatant, which is caused by vanadium ions in solution, is obtained (FIG. 1b). It is important to note that the green supernatant observed at this stage is not MXene, but is instead dissolved V from small intermetallics, residual metal, and nanosized MAX phase present in the precursor. Therefore, it should be decanted as waste.

The multilayer powder was washed with DI water and centrifuged repeatedly until the pH of the supernatant was >5.5. The washing typically required >1.5 L of deionized water per 1 g etched MAX phase. The ml-V₂CTₓ can be immediately delaminated (using the wet powder), dried for storage, or used and processed directly.

The ml-V₂CTₓ powder exhibits a dark brown color compared to the grey MAX phase, which can be seen in FIGS. 9B and 9C respectively. There is no apparent optical difference between the loose ml-V₂CTₓ powders etched by HF or mixed acid etching, but when the multilayer powders are pressed into pellets, the mixed acid etch is brighter and more golden in color (FIGS. 9D, 9E). X-ray diffraction (XRD) patterns were collected at each stage of synthesis for both etching methods and are shown in FIG. 1C. For preparation of XRD samples, V₂CTₓ was prepared simultaneously using both etching methods, followed by identical drying procedures. The multilayer powders were dried on a vacuum filter, followed by 24 hours in a vacuum desiccator at RT. The powders were subsequently crushed into a fine powder and dried for an additional 48 hours in the vacuum desiccator. 200 mg of each multilayer powder was pressed into pellets at 50 MPa to orient the MXene powders along their basal planes. The shift of the (002) peak, from 13.440 in V₂AlC to 9.22° (mixed acid etch) and 8.98° (HF etch) for ml-V₂CTₓ is attributed to the successful removal of Al from V₂AlC and subsequent expansion of the d₍₀₀₂₎-spacing from 6.6 Å to 10 Å and 9.6 Å, respectively. The intensity of the MXene (002) peak relative to the MAX phase peaks is greater in the mixed acid etch, which is indicative of a more complete etching of the Al layers with higher yield of V₂CTₓ MXene from the mixed acid etch. These XRD characteristics can be directly compared between the samples due to the identical precursor, processing conditions, and sample preparation. The SEM images in FIGS. 1D-1F compare the layered structure of the V₂AlC MAX phase with the obtained ml-V₂CTₓ. Both ml-V₂CTₓ MXenes show an open and typical “accordion-like” structure (FIG. 1E-1F).

### Delamination and Ion-Exchange Process

The ml-V₂CTₓ powders are delaminated using tetrabutylammonium hydroxide (TBAOH; denoted TBA-V₂CTₓ), or tetramethylammonium hydroxide (TMAOH; denoted TMA-V₂CTₓ). For best results (higher yield), delamination should be done immediately following etching and using the wet multilayer powder, however, it is also possible to delaminate vacuum-filter dried MXene powders. In the latter case, one can store the dried ml-V₂CTₓ powder under inert atmosphere (i.e. inside Ar-filled glovebox), and take it out when the delamination will be done.

The delamination protocols for TMAOH were as follows: ˜1 g of freshly etched ml-V₂CTₓ powder (in wet state) was added to 20 mL of a 5 wt. % TMAOH solution in water, and the solution was stirred at 400 rpm at room temperature (25° C.) for 6 hours. Alternatively, when dried ml-V₂CTₓ is used for delamination, 200 mg powder can be added to 10 mL of a 25 wt. % TMAOH solution in water, and the solution should be stirred at 400 rpm at 35° C. for 6 hours. Different delamination conditions are used because fresh (wet) multilayer MXene has preintercalated water between the layers, giving better ion mobility and intercalation,³⁴ enabling the process to occur more efficiently.

When MXene multilayer powders are dried, the interlayer spacing and ion mobility between the layers decreases as the result of water deintercalation, leading to sluggish delamination kinetics and lower yield. Therefore, to achieve a higher yield (˜50%), one can using the freshly etched wet powders to prepare dispersions of d-V₂CTₓ. Similar to TMAOH, the delamination protocols for TBAOH are: ˜1 g of freshly etched ml-V₂CTₓ powder was added to 20 mL of a 5 wt. % TBAOH solution in water, and the solution was stirred at 400 rpm at 25° C. for 6 hours. Alternatively, 200 mg of dried ml-V₂CTₓ was added to 10 mL of a 40 wt. % TBAOH solution in water, and the solution was stirred at 400 rpm at 35° C. for 6 hours.

After stirring in the delaminating agent, the intercalated multilayer powder is transferred to a centrifuge tube filled with DI water. The solution is centrifuged at 3500 rpm (2550 rcf) for 10 minutes and the first supernatant was discarded. The sediment is dispersed in DI water and shaken by hand for 2 minutes before centrifuging at 2500 rpm (1300 rcf) for 10 minutes (higher centrifuge speeds result in lower concentration of d-V₂CTₓ supernatant). It is crucial that the shaking process be performed for at least two minutes to ensure that the sediment is uniformly redispersed in fresh DI water. The second supernatant is once again discarded. After this stage, redispersion, hand shaking, and the 2500 rpm (1300 rcf) centrifugation is repeated with the supernatant being collected until the d-V₂CTₓ concentration is low (when supernatant turns to a blue-green color or becomes transparent). This process can use ˜1.2 L of water for 1 g of MXene.

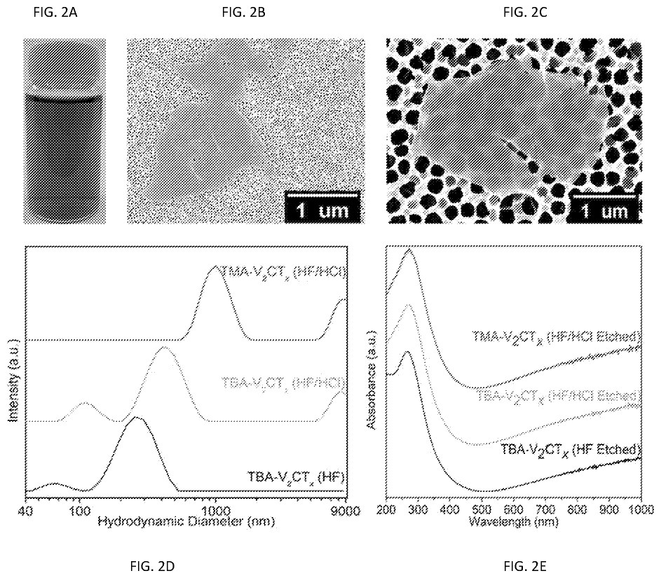

In FIG. 2a, the dilute TBA-V₂CTₓ solution (20 mL vial) is green-blue, while FIG. 2b,c shows SEM images of the TBA-V₂CTₓ flakes obtained from both HF and mixed acid etching methods drop-cast on an anodized aluminum oxide (AAO) membrane. Notably, depending on the type of the intercalant used, flakes with different physical properties are obtained; TMA⁺ molecules are smaller than TBA⁺, with hydrated ionic radii of 3.67 Å and 4.94 Å respectively, so the corresponding flake size tends to be larger in the case of TMA*.³⁵ This trend can be seen from the dynamic light scattering (DLS) measurements shown in FIG. 2d, and additionally, DLS reveals that the mixed acid etch results in larger flake sizes compared to HF etching.

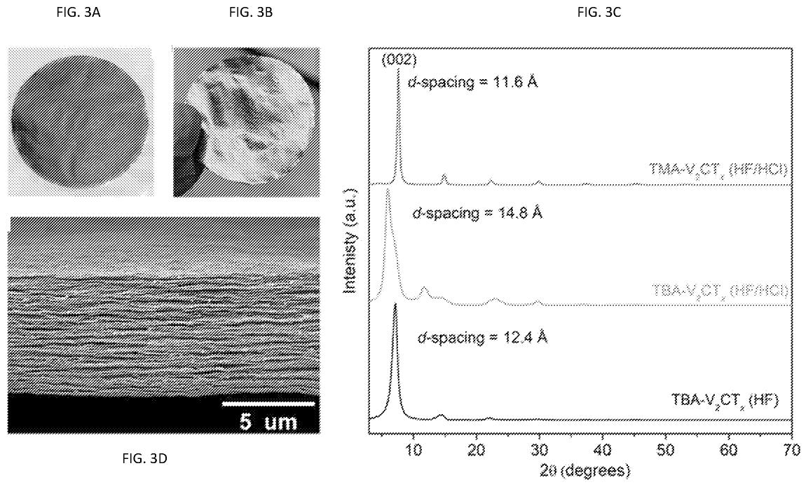

To study optical properties of the MXene colloids, UV-Vis spectra were collected from TBA-V₂CTₓ (HF and mixed acid) and TMA d-V₂CTₓ (mixed acid) colloids and are shown in FIG. 2e. The spectra for the HF etched sample shows a plateau in the low UV region (<250 nm), as seen in literature previously.⁴ Without being bound to any particular theory, this peak indicates the degradation of d-V₂CTₓ. The lack of such a peak or plateau in the mixed acid etched samples is an indicator that the mixed acid etch results in flakes with higher quality with minimal content of oxidized/degraded flakes immediately after synthesis. Binder free, freestanding flexible MXene films with a golden-brown color (shown in FIGS. 3a,b) were obtained by vacuum filtering (<20 mL) d-V₂CTₓ dispersed in water on a Celgard 3501 (0.22 μm pore size, 40 mm diameter) membrane. The SEM image in FIG. 3c shows the cross section of a TMA-V₂CTₓ vacuum filtered film with a typical layered stack of individual MXene flakes. Corresponding XRD patterns of d-V₂CTₓ films are shown in FIG. 3d. The d₍₀₀₂₎-spacing of films prepared from TMA-V₂CTₓ solutions (11.6 Å (2θ of 7.6°)) is smaller than TBA-V₂CTₓ due to the smaller intercalant size. The TBA-V₂CTₓ films from the HF etch and mixed acid etch show larger d₍₀₀₂₎-spacings of 12.4 Å (2θ of 7.1°) and 14.8 Å (20 of 5.95°), respectively. Without being bound to any particular theory, this variation could be the result of flake size difference, remaining stacks of few-layer flakes in the HF sample or an extra layer of water trapped in between the layers in the mixed acid sample.

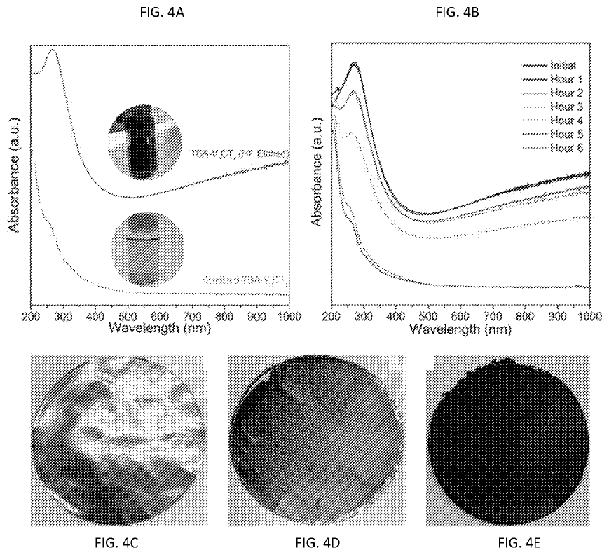

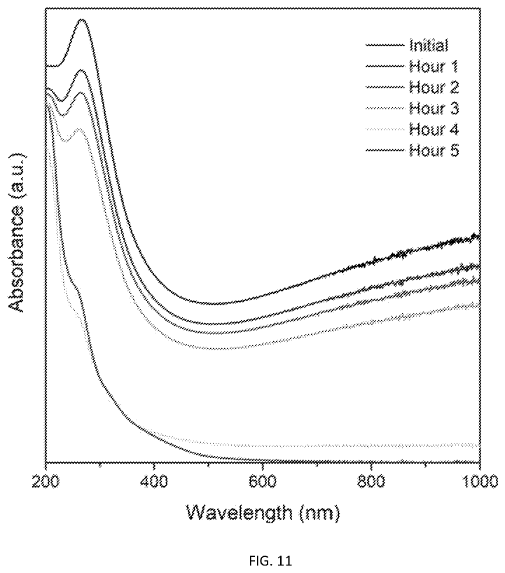

As reported previously,^{17,26} V₂CTₓ is unstable once delaminated. The rapid degradation of d-V₂CTₓ in water dispersions was studied using UV-Vis. The complete oxidation of TBA-V₂CTₓ (HF etched stored at 0.5 mg/mL) is shown in FIG. 4a, with a color change from green-blue to yellow in the solution. The appearance of a second low-UV peak below 250 nm, and a broad decrease in the intensity in the 500-1000 nm wavelength region further suggests the presence of vanadium oxide species in the oxidized solution.²² FIG. 4b shows the transformation of the spectra for dilute (0.1 mg/mL) TBA-V₂CTₓ synthesized from the mixed acid etch (the same style graph is shown for the HF etch in FIG. 11). The degradation begins immediately, with clear increases in the low UV region and reduction in the −275 nm V₂CTₓ peak, making the HF etched sample completely unusable after 3 hours and the mixed acid etch after 4 hours. It is worth noting that a 1-hour enhancement at such a dilute colloid may provide greater stability enhancements at higher concentrations.²⁹ This severe degradation is further shown in FIGS. 4c-e using films of TMA-V₂CTₓ (mixed acid etch), vacuum filtered from fresh colloid, a one-month-old colloid (stored in argon filled vial in refrigerator), and a film prepared from a fresh colloid that was then left in the open air for one month. In all cases the films appear darker (compared to the brownish gold color for fresh films), but the oxidation in air was more detrimental as seen by the color and flexibility. This degradation can also be seen from the decrease in electrical conductivity of the films after oxidation. The film in FIG. 4c exhibited a conductivity of 648 S cm ⁻¹, while the films in 4d and 4e had conductivities of 80 and 58 S cm⁻¹, respectively.

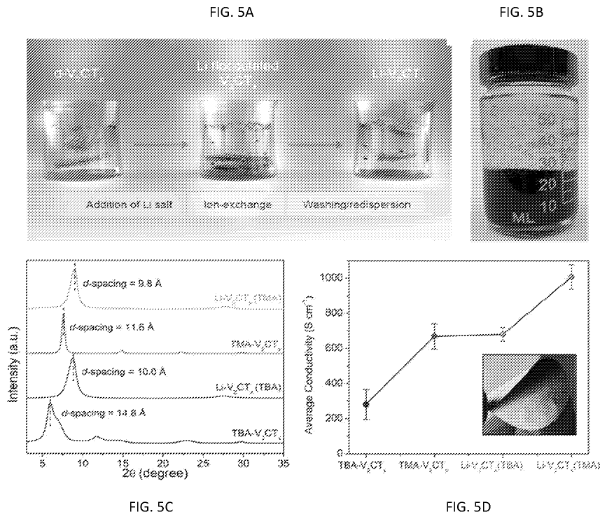

In order to overcome the rapid degradation and instability d-V₂CTₓ, an ion-exchange process was used to replace the residual TBA⁺ or TMA⁺ with smaller alkali cations. It is worth noting that, in our experience, delamination with large organic TBA⁺ or TMA⁺ molecules is one of the culprits for defect formation in V₂CTₓ flakes, the effect which may be more significant than harsh etching conditions. Therefore, development of etching and delamination procedures that eliminate the need for organic molecules and instead enable use of Li⁺ (or other alkali ions) will be beneficial. FIG. 5a schematically illustrates the ion exchange and flocculation processes used to remove residual organic intercalants, substitute them with Li cations, and redisperse d-V₂CTₓ solutions that now contain Li residuals.

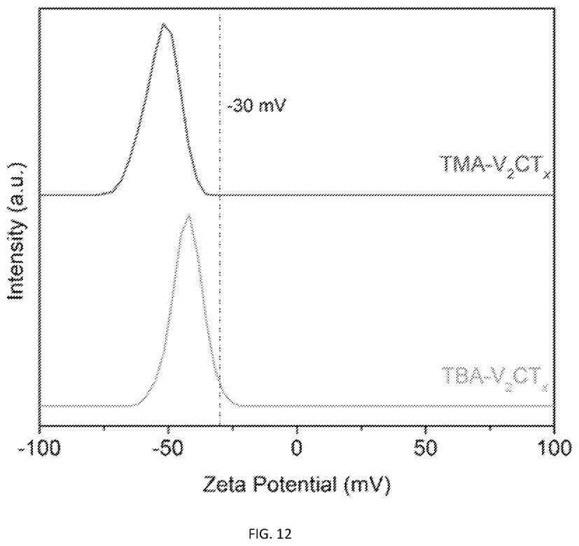

The ion exchange process removes adsorbed ions from the MXene surface (TBA⁺, TMA⁺) and replaces them with more desirable ions. This also results in tuning the MXene properties by changing their interlayer spacing and chemistry. An ion exchange process in multilayer Ti₃C₂Tₓ MXene was previously demonstrated.³⁴ In conjunction with the ion exchange process, flocculation occurs due to the electrostatic adsorbtion of cations on the negatively charged MXene surface. Previous reports of the zeta potential (surface charge) of HF etched d-V₂CTₓ showed an average zeta potential of −32.4, which is close to the limit of colloidal stability (−30 mV).⁴ Using the mixed acid etch, average zeta potentials of −41.8 and −52.0 mV were achieved for TBA⁺ and TMA⁺ delaminated V₂CTₓ respectively, which is shown in FIG. 12. With the addition of excess cations, flakes begin to crumple and restack in order to compensate the charge of the positive ion on the negatively charged flakes, and the flocculated flakes precipitate out of solution. Flocculation of Ti₃C₂Tₓ and V₂CTₓ have been demonstrated using acids and bases, such as HCl and NaOH, as well as some alkali salts.³⁶⁻³⁸

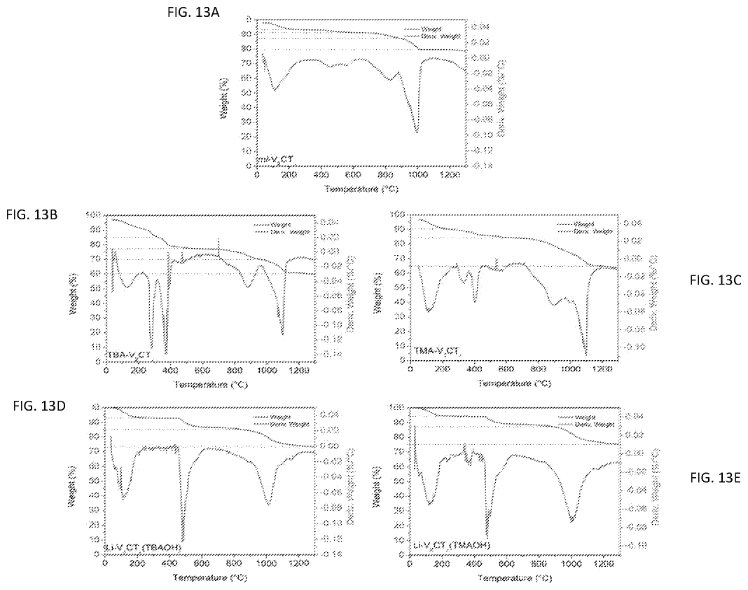

In order to perform ion-exchange and flocculation on TBA- or TMA-V₂CTₓ colloids, a saturated LiCl water dispersion (19.8 M) is used to exchange TMA⁺/TBA⁺ for Li⁺. In a typical process, a 1:5 volume ratio of 19.8 M LiCl solution to MXene solution (concentration of −0.5-1.0 mg/mL) was used. It is important to perform this process immediately after fresh d-V₂CTₓ solutions are prepared to avoid degradation. After the sample has been flocculated, it should be left to naturally settle before any further handling. After the flocs have completely settled, if the sample is going to be kept for long-term storage (more than two weeks), the supernatant, which contains TMA⁺/TBA⁺, H₂O, and excess Li⁺, should be removed and replaced with 19.8 M LiCl solution. This can be accomplished using a pipette to remove the clear supernatant over the the flocculated MXene, followed by replacing the same volume with 19.8 M LiCl. This maximizes the LiCl: water ratio, minimizing hydrolysis.³⁹ Centrifugation may yield the same result, but there may be a difference in the structure and stacking of the centrifuged flocs, which may affect redispersability. This process allows d-V₂CTₓ to be kept in a wet flocculated state (in a fridge) for storage until use. The flocculated V₂CTₓ can be redispersed by washing with DI water and removal of excess Li ions (similar to washing after conventional intercalation/delamination). In short, the wet precipitates are transferred to centrifuge tubes and centrifuged at 3500 rpm (2550 rcf) for 10 minutes in order to ensure sedimentation of the flocculated MXene. The supernatant is decanted, and the washing process is continued by redispersing the precipitates in DI water, followed by hand shaking for 2 minutes between cycles. This is typically repeated 3-5 times, using ˜750 mL of DI water for 1 g of V₂CTₓ Afterwards, the V₂CTₓ flakes start to redisperse in water (supernatant becomes green/blue), and the supernatant can be collected. The obtained solutions are labeled as Li-V₂CTₓ. The flocculated V₂CTₓ solutions are shown in FIG. 5b. For comparison, Li—V₂CTₓ was prepared from TBA-V₂CTₓ (1F and mixed acid etch) as well as TMA-V₂CTₓ (mixed acid etch), and XRD analysis was performed on the vacuum filtered films. There is a clear and distinct shift in the position of (00/) basal planes of V₂CTₓ toward higher Bragg angles (smaller d-spacing) after ion-exchange, which indicates substitution of the majority of large TBA⁺/TMA⁺ ions with smaller Li⁺ in the interlayer space. Moreover, there is a negligible difference in the d₍₀₀₂₎-spacing (0.2 Å) of the Li-V₂CTₓ films obtained from TMA or TBA-V₂CTₓ solutions (FIG. 5c), which indicates that the ion exchange process can be done efficiently on both of these intercalants. The removal of residual TBA⁺ and TMA⁺ during the ion-exchange process was further investigated by using thermogravimetric analysis (TGA) as shown in FIG. 13a-e. Both TBA and TMA delaminated V₂CTₓ samples showed a notable weight loss at ˜400° C. (FIG. 13 b and c) which is attributed to the decomposition and removal of residual intercalants (TBA⁺ or TMA⁺).⁴⁰ However, similar to ml-V₂CTₓ, the TGA analysis of Li ion-exchanged V₂CTₓ samples did not show a weight loss peak in this temperature range, suggesting removal of residual TBA and TMA intercalants in these samples and high efficiency of the ion-exchange process.

In addition, compared to the previous report on ion-exchanged Li-V₂CTₓ vacuum filtered films, our optimized process results in a more efficient removal of residual TBA⁺ or TMA⁺.¹⁹ This can be seen from the obtained d-spacing values, where our Li-V₂CTₓ films (prepared from TBA delaminated solutions) show a d₍₀₀₂₎ of ˜10.0 Λ whereas a value of 12.2 Å was reported in the previous work.¹⁹ FIG. 5d shows the conductivities of the V₂CTₓ films obtained from vacuum filtration of different V₂CTₓ solutions with different intercalants. The Li-V₂CTₓ freestanding films exhibit electrical conductivity >1,000 S cm⁻¹ without annealing, roughly twice previous reports.²¹ The observed differences in the electrical conductivities of TBA or TMA-V₂CTₓ and their corresponding Li-V₂CTₓ films are likely due to differences in V₂CTₓ flake size and quality. Larger V₂CTₓ flake sizes in TMA intercalated films generally result in higher electrical conductivity compared to TBA intercalated films (a similar relationship has been reported for Ti₃C₂Tₓ).⁴¹ The decrease in the interlayer spacing of all Li-V₂CTₓ films further facilitates inter-flake electron transport and, therefore, these films show the highest electrical conductivity. Li—V₂CTₓ obtained from TMA-V₂CTₓ solution shows a slightly higher conductivity as the result of its larger flake size. Additional factors that may influence the conductivity include the cations and water present in the interlayer of the V₂CTₓ, but these factors are complex and not currently well understood. The ion exchange and flocculation process can be performed with other ions, as Na⁺ and Mg²⁺ have been demonstrated previously.¹⁹ In some cases, monovalent, high molarity salts (e.g., 30 m potassium acetate) can be used similarly.

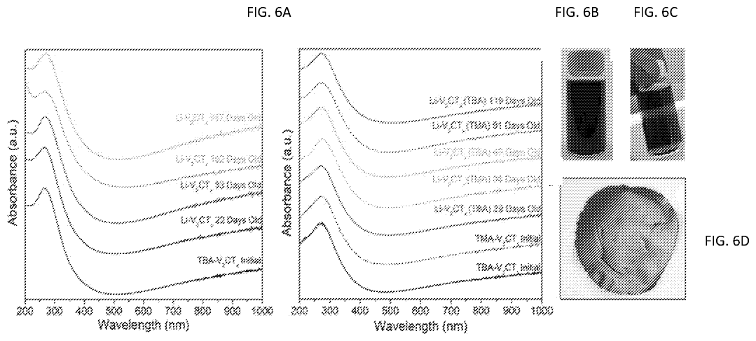

The stability of the redispersed Li-V₂CTₓ solutions was studied via UV-Vis as shown in FIG. 6a. TBA-V₂CTₓ (1F etched) was kept in the flocculated state and redispersed after 33 and 147 days. Even after 147 days, the increase in the low UV region peak was minor and within the limits of what has been considered pristine d-V₂CTₓ solutions in previous works.⁴ This 147-day old Li-V₂CTₓ solution showed no visible signs of degradation, as seen in FIG. 6b,c. The solution was subsequently vacuum filtered into a film that showed bright golden-brown color and good flexibility (FIG. 6d) in contrast to the TMA-V₂CTₓ (FIG. 4d) which was prepared only after 30 days of storage. It is worth noting that the 102-day old sample had higher degradation than the 147-day old sample, which we assume is due to variation in the original samples. The same UV-Vis experiment was performed on Li⁺ exchanged TMA and TBA-V₂CTₓ (mixed acid etched) solutions, and the sample stability was checked at various times. Both mixed acid etched samples show no change in the UV-Vis spectra, indicating no degradation over time. This is in agreement with visual observations where the diluted redispersed Li-V₂CTₓ solution showed no distinctive color change after 119 days and preserved its greenish blue color.

Solution Processing of Li-V₂CTₓ

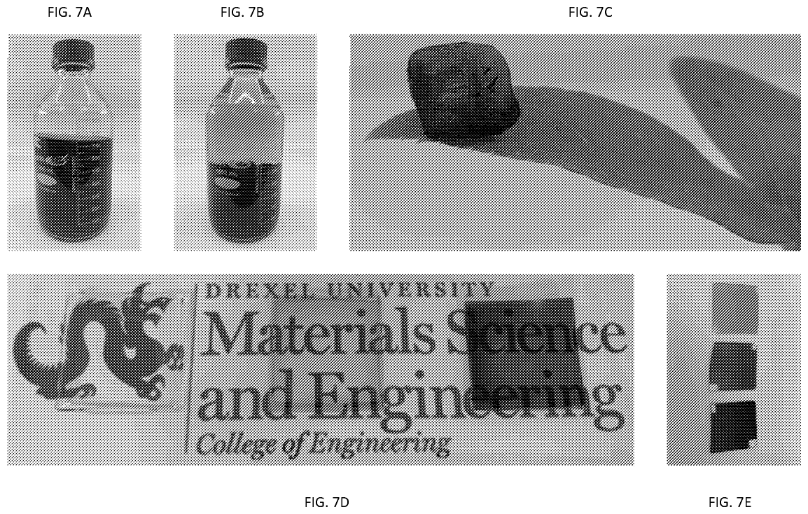

The improved quality and long-term stability of Li-V₂CTₓ enables processing of these solutions in a variety of different ways, similar to Ti₃C₂Tₓ. As a proof of concept and for practicality and useability of the produced V₂CTₓ solutions, we demonstrate a few common processing techniques to fabricate V₂CTₓ materials with different forms and structures. FIGS. 7a,b show a 750 mL bottle of TMA-V₂CTₓ solution and the flocculated Li-V₂CTₓ, respectively. After redispersing, the Li-V₂CTₓ solution was freeze-dried into an aerogel (FIG. 7c), which can be used for EMI shielding, adsorption, and electrochemical applications. The prepared Li-V₂CTₓ solutions can be used to prepare hydrogels as well.

Hydrogels of varying transparency were prepared using mixtures of Li-V₂CTₓ and PVA solutions in different ratios. The hydrogels (FIG. 7d) showed distinct optical properties and mechanical flexibility. They can be used in biomedical applications like physiological sensors and bioelectronic interfaces, as well as electrochemical applications related to flexible, solid-state energy storage. Moreover, The V₂CTₓ solutions can also be processed using spray coating. Transparent thin film V₂CTₓ coatings were prepared by spray coating the Li-V₂CTₓ solution with varying thicknesses onto glass slides (FIG. 7e). This is a relatively low-cost, simple method to generate transparent, conductive electrodes for electrochemical and optoelectronic applications. These examples demonstrate that the improved stability and properties of V₂CTₓ MXene obtained through protocols and methods explained in this paper can open new pathways for practical use of V₂CTₓ in wide-range of new applications.

### Characterization Techniques and Procedure

A Zeiss Supra 50VP SEM was used for imaging of V₂AlC powder, multilayered and delaminated V₂CTₓ, and vacuum filtered films. A Rigaku Smart Lab and powder diffractometer with a Cu Kα target was used to collect XRD patterns from samples. MAX phase samples were scanned from 3-90° 20, while MXene samples were scanned from 3-70° 2θ. A current of 15 mA and a voltage of 40 kV were used with a step size of 0.02° 2θ and a duration time of 0.4 seconds. An Evolution 201 UV-Vis spectrophotometer (Thermo Scientific, MA, USA) with a 10 mm optical path length, quartz cuvette was used for analyses of optical properties. Spectra were collected from 200 to 1000 nm. Electrical conductivity of vacuum filtered V₂CTₓ films and pressed multilayer V₂CTₓ pellets were measured using a four-point probe conductivity measurement technique equipped with a 1 mm probe (Jandel Engineering Ltd., Bedforshire, UK). The measured sheet resistance was converted to conductivity (S cm⁻¹) by factoring in the calculated thicknesses from either SEM or micrometer. Flake size and Zeta potential of solutions were estimated using a Malvern Panalytical Zetasizer Nano ZS in a folded capillary disposable cuvette. Five measurements were recorded in both cases, with the average being recorded.

### SUMMARY

In this disclosure, we show how to overcome stability limitations when working with V₂CTₓ, which is known as one of the least stable MXenes. The viability of using a mixed acid etchant for MXene synthesis was shown. We developed an efficient and robust ion-exchange protocol that increases its chemical stability, both in wet and dry form. Most important, the stability of delaminated V₂CTₓ MXene in aqueous solutions increased from a few hours to several months, opening new horizons for MXene applications. This ion exchange process enables tuning of the interlayer space, resulting in an increased electrical conductivity of V₂CTₓ free-standing films above all the values reported in the literature. We have demonstrated and discussed improved etching, delamination, and storage approaches and protocols for V₂CTₓ. Therefore, this work can be looked at as a comprehensive guideline for synthesis of chemically stable MXene solutions (e.g., including V₂CTₓ) and films with improved properties.

### General Applicability of Mixed Acid Etch and Ion Exchange Method

The mixed acid etch described in the main text was performed on three different MAX phase precursors. The “Conventional MAX” was synthesized via the protocols described in the main text. As for the “High Al” MAX phase, the same synthesis conditions were used, but a higher aluminum content was introduced, similar to for the method described for Ti₃C₂Tₓ.¹ The “Carbon Ukraine MAX” sample was obtained from Carbon Ukraine, Ltd. The XRD patterns of the corresponding MAX phases are shown in FIG. 9a; demonstrating variations in the impurities present between the samples. These XRD patterns were collected after acid washing the samples according to the protocol described in the main text.

The different MAX phase precursors were all etched using the mixed acid etch, delaminated with TBAOH, and flocculated/exchanged with Li⁺ to study the stability of the samples. In FIG. 9b, the UV-Vis spectra of the redispersed Li-V₂CTₓ samples from different MAX phase precursors are shown. The Conventional MAX phase and High Al sample show no signs of degradation, while the Carbon Ukraine sample shows minimal oxidation. The SEM images in FIGS. 9c-e show smoother particulates from the MAX phases synthesized in the lab compared to the milled commercial powder. The small particles in the Carbon Ukraine sample could be easier to oxidize. However, the UV-Vis spectra of the 104-day old Carbon Ukraine sample still only showed minimal oxidation. Thus, Li—V₂CTₓ MXenes prepared from all three precursors display enhanced stability. This demonstrates versatility and universal applicability of the developed process.

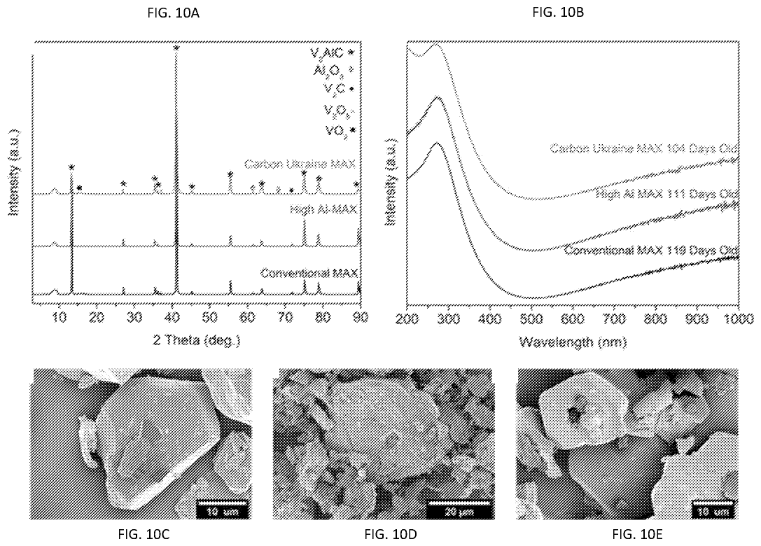

In order to further characterize the water and residual intercalant contents of the as-synthesized V₂CTₓ as well as ion exchanged V₂CTₓ, thermogravimetric analysis (TGA) was performed in an argon atmosphere on samples at different stages of synthesis and post-processing. In FIG. 10a, the TGA plot for ml-V₂CTₓ is shown. FIGS. 10B and 10C show the TGA plots for TBA- and TMA-V₂CTₓ, respectively. Also, FIGS. 10D and 10E show TGA plots for Li-V₂CTₓ made from TBAOH and TMAOH, respectively.

TGA data reveal more information about water content and residual TBA⁺ and TMA⁺ cations in different V₂CTₓ samples before and after delamination as well as the efficacy of ion-exchange process. ml-V₂CTₓ (FIG. 12A) shows a three-stage weight loss (within the temperature range up to ˜700° C.) starting with an initial desorption of physiosorbed water from ˜50-225° C. At higher temperatures (˜380-600° C.) dissociation of surface functional groups occurs and also chemisorbed or structural water is removed from multilayer powders. V₂CTₓ MXene starts to degrade at around ˜600° C. in inert atmosphere.² The degradation becomes more significant as the temperature is increased. The weight loss starting at −700° C. is due to degradation of MXene structure, as also previously shown for Ti₃C₂Tₓ.³

In contrast to ml-V₂CTₓ, up to −700° C., TBA delaminated V₂CTₓ shows a four-stage weight loss in its TGA pattern (FIG. 12b). A larger weight loss at ˜60-200° C. followed by a notable weight loss at around ˜250-320° C. can be attributed to removal of water from the structure. Without being bound to any theory, one may assume that TBA co-intercalates more water molecules during delamination, as also evident from its larger d₍₀₀₀ₗ₎-spacing. The third stage of weight loss can be seen at ˜325-430° C., which is due to the decomposition and removal of the residual TBA ions from MXene.³ A similar trend is observed for TMA delaminated V₂CTₓ (FIG. 12c). However, in case of ion exchanged Li-V₂CTₓ samples prepared from the TBA or TMA (FIG. 12d,e), the weight loss at low temperatures is less (similar to that of ml-V₂CTₓ) and also the weight loss peak at ˜325-430° C. is absent, which indicates that residual TBA or TMA cations are completely removed from the structure during the ion-exchange process. Similar to ml-V₂CTₓ, but at slightly higher onset temperatures, both samples show the second stage weight loss at 445° C. related to dissociation of surface functional groups and removal of chemisorbed water. These results further support the decreased d₍₀₀₀ₗ₎-spacing and increased electrical conductivity of Li-V₂CTₓ, films after ion-exchange process and shed light on the effectiveness of this process to remove residual TBA or TMA cations and exchange them with Li⁺ or other alkali cations.

TABLE 1
Etching Configurations Tests

| Etching Conditions (Per 1 g | |
|---|---|
| V₂AlC) 12 mL (48%) HF: | |
| 8 mL (12M) HCl at 50° C. | Result |
| 48 hours | Low yield, likely under-etched |
| 60 hours | Yield below 50%, no initial oxidation |
| 72 hours | Yield above 50%, no initial oxidation |

TABLE 2
Nomenclature Guide

| Abbreviation | Explanation |
|---|---|
| V₂CTₓ | Vanadium carbide MXene |
| ml-V₂CTₓ | Multilayered vanadium carbide MXene |
| d-V₂CTₓ | Delaminated vanadium carbide MXene (general) |
| TBA-V₂CTₓ | Vanadium carbide MXene delaminated with TBAOH |
| TMA-V₂CTₓ | Vanadium carbide MXene delaminated with TMAOH |
| Li-V₂CTₓ | Lithium ion exchanged with TBA- or TMA-V₂CTₓ |

TABLE 3
Chemical Suppliers List

| Material/Chemical | Supplier |
|---|---|
| Vanadium (99.5%, −325 mesh) | Alfa Aesar |
| Aluminum (99.5%, −325 mesh) | Alfa Aesar |
| Graphite (99%, −325 mesh) | Alfa Aesar |
| 9M HCl | Fischer Scientific, U.S. |
| 48 wt. % HF | Acros Organics, Fair Lawn, NJ |
| 25 wt. % TMAOH | Sigma Aldrich |
| 40 wt. % TBAOH | Alfa Aesar |

### Aspects

The following Aspects are illustrative only and do not limit the scope of the present disclosure or the appended claims. Any one or more parts of any Aspect can be combined with any one or more parts of any other Aspect.

Aspect 1. A method, comprising: providing a solution of delaminated MXene material and a first ionic intercalant; and contacting the solution with a second ionic intercalant so as to exchange the first ionic intercalant and the second ionic intercalant so as to give rise to flocculated portions of the MXene material and a supernatant that comprises the first ionic intercalant and the second ionic intercalant.

Aspect 2. The method of Aspect 1, further comprising replacing at least some of the supernatant with a saturated solution of the second ionic intercalant.

Aspect 3. The method of Aspect 2, wherein the saturated solution of the second ionic intercalant is a supersaturated solution.

Aspect 4. The method of any one of Aspects 1-3, wherein the first ionic intercalant comprises an organic base, the organic base optionally comprising TMAOH, TBAOH, TEAOH, TPAOH or any combination thereof.

Aspect 5. The method of any one of Aspects 1-4, wherein the method of any one of Aspects 1-4, wherein the second ionic intercalant comprises an alkali cation-containing inorganic salt, the alkali cation-containing inorganic salt optionally comprising LiCl, NaCl, KCl, MgCl₂, CaCl₂, Li₂SO₄, K₂SO₄. MgSO₄, Na₂SO₄, LiOH, NaOH, KOH, or any combination thereof.

Aspect 6. The method of any one of Aspects 1-5, wherein the flocculated portions of MXene material are one or both of single layer MXene or few-layer MXene. (A few-layer MXene has from 2 to 5 atomic layers.)

Aspect 7. The method of any one of Aspects 1-7, wherein the MXene has the formula Mₙ₊₁CₙTₓ, wherein M is V.

Aspect 8. The method of Aspect 8, wherein the MXene has the formula of V₂CTₓ.

Aspect 9. The method of any one of Aspects 1-6, further comprising redispersing the flocculated MXene portions in solution.

Aspect 10. The method of Aspect 9, wherein the flocculated portions of MXene material remain essentially undegraded after storage under ambient conditions for 150 days.

Aspect 11. A MXene dispersion, comprising a plurality of portions of single-layer and/or few-layer MXene dispersed in a solvent, the solvent comprising a first ionic intercalant and a second ionic intercalant.

Aspect 12. The MXene dispersion of Aspect 11, wherein the first ionic intercalant comprises TMAOH and/or TBAOH.

Aspect 13. The MXene dispersion of any one of Aspects 11-12, wherein the second ionic intercalant comprises LiCl.

Aspect 14. The MXene dispersion of any one of Aspects 11-13, wherein the MXene has the formula Mₙ₊₁CₙTₓ, wherein M is V.

Aspect 15. The MXene dispersion of Aspect 14, wherein the MXene has the formula of V₂CTₓ.

Aspect 16. A stable MXene dispersion, comprising a plurality of portions of single-layer and/or few-layer MXene dispersed in a solvent, the solvent comprising an ionic intercalant, the ionic intercalant optionally being present in supersaturated form.

Aspect 17. The stable MXene dispersion of Aspect 16, wherein the ionic intercalant comprises LiCl.

Aspect 18. The stable MXene dispersion of any one of Aspects 16-17, wherein the MXene has the formula Mₙ₊₁CₙTₓ, wherein M is V.

Aspect 19. The stable MXene dispersion of Aspect 18, wherein the MXene has the formula of V₂CTₓ.

Aspect 20. The stable MXene dispersion of any one of Aspects 16-19, wherein the MXene remains essentially undegraded after storage under ambient conditions for 100 days.

### REFERENCES

(1) Naguib, M.; Kurtoglu, M.; Presser, V.; Lu, J.; Niu, J.; Heon, M.; Hultman, L.; Gogotsi, Y.; Barsoum, M. W. Two-Dimensional Nanocrystals Produced by Exfoliation of Ti₃AlC₂. Adv. Mater. 2011, 23 (37), 4248-4253. https://doi.org/10.1002/adma.201102306.
(2) Anasori, B.; Lukatskaya, M. R.; Gogotsi, Y. 2D Metal Carbides and Nitrides (MXenes) for Energy Storage. Nat. Rev. Mater. 2017, 2 (2). https://doi.org/10.1038/natrevmats.2016.98.
(3) Shahzad, F.; Alhabeb, M.; Hatter, C. B.; Anasori, B.; Hong, S. M.; Koo, C. M.; Gogotsi, Y. Electromagnetic Interference Shielding with 2D Transition Metal Carbides (MXenes). Science 2016, 353 (6304), 1137-1140. https://doi.org/10.1126/science.aag2421.
(4) Iqbal, A.; Shahzad, F.; Hantanasirisakul, K.; Kim, M. K.; Kwon, J.; Hong, J.; Kim, H.; Kim, D.; Gogotsi, Y.; Koo, C. M. Anomalous Absorption of Electromagnetic Waves by 2D Transition Metal Carbonitride Ti₃CNTx (MXene). Science 2020, 369 (6502), 446-450. https://doi.org/10.1126/science.aba7977.
(5) Lee, E.; Vahidmohammadi, A.; Prorok, B. C.; Yoon, Y. S.; Beidaghi, M.; Kim, D. J. Room Temperature Gas Sensing of Two-Dimensional Titanium Carbide (MXene). ACS Appl. Mater. Interfaces 2017, 9 (42), 37184-37190. https://doi.org/10.1021/acsami.7b11055.
(6) Kim, S. J.; Koh, H. J.; Ren, C. E.; Kwon, O.; Maleski, K.; Cho, S. Y.; Anasori, B.; Kim, C. K.; Choi, Y. K.; Kim, J.; Gogotsi, Y.; Jung, H. T. Metallic Ti₃C₂Tₓ MXene Gas Sensors with Ultrahigh Signal-to-Noise Ratio. ACS Nano 2018, 12 (2), 986-993. https://doi.org/10.1021/acsnano.7b07460.
(7) Lyu, B.; Kim, M.; Jing, H.; Kang, J.; Qian, C.; Lee, S.; Cho, J. H. Large-Area MXene Electrode Array for Flexible Electronics. ACS Nano 2019, 13 (10), 11392-11400. https://doi.org/10.1021/acsnano.9b04731.
(8) Melianas, A.; Kang, M.; Vahidmohammadi, A.; Tian, W.; Gogotsi, Y. High-Speed Ionic Synaptic Memory Based on Two-Dimensional Titanium Carbide MXene. Arxiv 2021.
(9) Meng, F.; Seredych, M.; Chen, C.; Gura, V.; Mikhalovsky, S.; Sandeman, S.; Ingavle, G.; Ozulumba, T.; Miao, L.; Anasori, B.; Gogotsi, Y. MXene Sorbents for Removal of Urea from Dialysate: A Step toward the Wearable Artificial Kidney. ACS Nano 2018, 12, 10518-10528.
(10) Mojtabavi, M.; Vahidmohammadi, A.; Liang, W.; Beidaghi, M.; Wanunu, M. Single-Molecule Sensing Using Nanopores in Two-Dimensional Transition Metal Carbide (MXene) Membranes. ACS Nano 2019, 13 (3), 3042-3053. https://doi.org/10.1021/acsnano.8b08017.
(11) Lin, H.; Wang, X.; Yu, L.; Chen, Y.; Shi, J. Two-Dimensional Ultrathin MXene Ceramic Nanosheets for Photothermal Conversion. Nano Lett. 2017, 17 (1), 384-391. https://doi.org/10.1021/acs.nanolett.6b04339.
(12) Naguib, M.; Mochalin, V. N.; Barsoum, M. W.; Gogotsi, Y. 25th Anniversary Article: MXenes: A New Family of Two-Dimensional Materials. Adv. Mater. 2014, 26 (7), 992-1005. https://doi.org/10.1002/adma.201304138.
(13) 2D Metal Carbides and Nitrides (MXenes): Structure, Properties and Applications; Anasori, B., Gogotsi, Y., Eds.; Springer International Publishing, Cham, 2019. https://doi.org/10.1007/978-3-030-19026-2.
(14) Vahidmohammadi, A.; Hadjikhani, A.; Shahbazmohamadi, S.; Beidaghi, M. Two-Dimensional Vanadium Carbide (MXene) as a High-Capacity Cathode Material for Rechargeable Aluminum Batteries. ACS Nano 2017, 11 (11), 11135-11144. https://doi.org/10.1021/acsnano.7b05350.
(15) Naguib, M.; Halim, J.; Lu, J.; Cook, K. M.; Hultman, L.; Gogotsi, Y.; Barsoum, M. W. New Two-Dimensional Niobium and Vanadium Carbides as Promising Materials for Li-Ion Batteries. J. Am. Chem. Soc. 2013, 135 (43), 15966-15969. https://doi.org/10.1021/ja405735d.
(16) VahidMohammadi, A.; Mojtabavi, M.; Caffrey, N. M.; Wanunu, M.; Beidaghi, M. Assembling 2D MXenes into Highly Stable Pseudocapacitive Electrodes with High Power and Energy Densities. Adv. Mater. 2019, 31 (8), 1-9. https://doi.org/10.1002/adma.201806931.
(17) Lee, E.; VahidMohammadi, A.; Yoon, Y. S.; Beidaghi, M.; Kim, D.-J. Two-Dimensional Vanadium Carbide MXene for Gas Sensors with Ultrahigh Sensitivity Toward Nonpolar Gases. ACS Sensors 2019, 4 (6), 1603-1611. https://doi.org/i0.1021/acssensors.9b00303.
(18) Liu, F.; Zhou, J.; Wang, S.; Wang, B.; Shen, C.; Wang, L.; Hu, Q.; Huang, Q.; Zhou, A. Preparation of High-Purity V 2 C MXene and Electrochemical Properties as Li-Ion Batteries. J. Electrochem. Soc. 2017, 164 (4), A709-A713. https://doi.org/10.1149/2.0641704jes.
(19) Bak, S. M.; Qiao, R.; Yang, W.; Lee, S.; Yu, X.; Anasori, B.; Lee, H.; Gogotsi, Y.; Yang, X. Q. Na-Ion Intercalation and Charge Storage Mechanism in 2D Vanadium Carbide. Adv. Energy Mater. 2017, 7 (20), 1-9. https://doi.org/10.1002/aenm.201700959.
(20) Shan, Q.; Mu, X.; Alhabeb, M.; Shuck, C. E.; Pang, D.; Zhao, X.; Chu, X. F.; Wei, Y.; Du, F.; Chen, G.; Gogotsi, Y.; Gao, Y.; Dall'Agnese, Y. Two-Dimensional Vanadium Carbide (V2C) MXene as Electrode for Supercapacitors with Aqueous Electrolytes. Electrochem. commun. 2018, 96, 103-107. https://doi.org/10.1016/j.elecom.2018.10.012.
(21) Dall'Agnese, Y.; Taberna, P. L.; Gogotsi, Y.; Simon, P. Two-Dimensional Vanadium Carbide (MXene) as Positive Electrode for Sodium-Ion Capacitors. J. Phys. Chem. Lett. 2015, 6 (12), 2305-2309. https://doi.org/10.1021/acs.jpclett.5b00868.
(22) Yan, B.; Lu, C.; Zhang, P.; Chen, J.; He, W.; Tian, W.; Zhang, W.; Sun, Z. M. Oxygen/Sulfur Decorated 2D MXene V2C for Promising Lithium Ion Battery Anodes. Mater. Today Commun. 2020, 22 (August 2019), 100713. https://doi.org/10.1016/j.mtcomm.2019.100713.
(23) Champagne, A.; Shi, L.; Ouisse, T.; Hackens, B.; Charlier, J. C. Electronic and Vibrational Properties of V2 C-Based MXenes: From Experiments to First-Principles Modeling. Phys. Rev. B 2018, 97 (11), 1-11. https://doi.org/10.1103/PhysRevB.97.115439.
(24) Urbankowski, P.; Anasori, B.; Hantanasirisakul, K.; Yang, L.; Zhang, L.; Haines, B.; May, S. J.; Billinge, S. J. L.; Gogotsi, Y. 2D Molybdenum and Vanadium Nitrides Synthesized by Ammoniation of 2D Transition Metal Carbides (MXenes). 2017, No. April 2018. https://doi.org/10.1039/C7NR06721F.
(25) Ying, G.; Kota, S.; Dillon, A. D.; Fafarman, A. T.; Barsoum, M. W. Conductive Transparent V2CTx (MXene) Films. FlatChem 2018, 8, 25-30. https://doi.org/https://doi.org/10.1016/j.flatc.2018.03.001.
(26) Thakur, R.; Vahidmohammadi, A.; Moncada, J.; Adams, W. R.; Chi, M.; Tatarchuk, B.; Beidaghi, M.; Carrero, C. A. Insights into the Thermal and Chemical Stability of Multilayered V2CT: X MXene. Nanoscale 2019, 11 (22), 10716-10726. https://doi.org/10.1039/c9nrO3020d.
(27) Naguib, M.; Unocic, R. R.; Armstrong, B. L.; Nanda, J. Large-Scale Delamination of Multi-Layers Transition Metal Carbides and Carbonitrides “MXenes.” Dalt. Trans. 2015, 44 (20), 9353-9358. https://doi.org/10.1039/c5dt01247c.
(28) Alhabeb, M.; Maleski, K.; Anasori, B.; Lelyukh, P.; Clark, L.; Sin, S.; Gogotsi, Y. Guidelines for Synthesis and Processing of Two-Dimensional Titanium Carbide (Ti3C2Tx MXene). Chem. Mater. 2017, 29 (18), 7633-7644. https://doi.org/10.1021/acs.chemmater.7b02847.
(29) Natu, V.; Hart, J. L.; Sokol, M.; Chiang, H.; Taheri, M. L.; Barsoum, M. W. Edge Capping of 2D-MXene Sheets with Polyanionic Salts To Mitigate Oxidation in Aqueous Colloidal Suspensions. Angew. Chemie-Int. Ed. 2019, 58 (36), 12655-12660. https://doi.org/10.1002/anie.201906138.
(30) Zhao, X.; Vashisth, A.; Blivin, J. W.; Tan, Z.; Holta, D. E.; Kotasthane, V.; Shah, S. A.; Habib, T.; Liu, S.; Lutkenhaus, J. L.; Radovic, M.; Green, M. J. PH, Nanosheet Concentration, and Antioxidant Affect the Oxidation of Ti3C2Tx and Ti2CTₓ MXene Dispersions. Adv. Mater. Interfaces 2020, 7 (20), 2000845. https://doi.org/10.1002/admi.202000845.
(31) Lipatov, A.; Alhabeb, M.; Lukatskaya, M. R.; Boson, A.; Gogotsi, Y.; Sinitskii, A. Effect of Synthesis on Quality, Electronic Properties and Environmental Stability of Individual Monolayer Ti₃C₂ MXene Flakes. Adv. Electron. Mater. 2016, 2 (12), 1600255. https://doi.org/10.1002/aelm.201600255.
(32) Mathis, T. S.; Maleski, K.; Goad, A.; Sarycheva, A.; Anayee, M.; Foucher, A. C.; Hantanasirisakul, K.; Shuck, C. E.; Stach, E. A.; Gogotsi, Y. Modified MAX Phase Synthesis for Environmentally Stable and Highly Conductive Ti₃C₂ MXene. ACS Nano 2021.
(33) Ghidiu, M.; Halim, J.; Kota, S.; Bish, D.; Gogotsi, Y.; Barsoum, M. W. Ion-Exchange and Cation Solvation Reactions in Ti3C2 MXene. Chem. Mater. 2016, 28 (10), 3507-3514. https://doi.org/10.1021/acs.chemmater.6b01275.
(34) Zhao, D.; Clites, M.; Ying, G.; Kota, S.; Wang, J.; Natu, V.; Wang, X.; Pomerantseva, E.; Cao, M.; Barsoum, M. W. Alkali-Induced Crumpling of Ti3C2T: X (MXene) to Form 3D Porous Networks for Sodium Ion Storage. Chem. Commun. 2018, 54 (36), 4533-4536. https://doi.org/10.1039/c8cc00649k.
(35) Natu, V.; Clites, M.; Pomerantseva, E.; Barsoum, M. W. Mesoporous MXene Powders Synthesized by Acid Induced Crumpling and Their Use as Na-Ion Battery Anodes. Mater. Res. Lett. 2018, 6 (4), 230-235. https://doi.org/10.1080/21663831.2018.1434249.
(36) Deng, Y.; Shang, T.; Wu, Z.; Tao, Y.; Luo, C.; Liang, J.; Han, D.; Lyu, R.; Qi, C.; Lv, W.; Kang, F.; Yang, Q. H. Fast Gelation of Ti3C2Tx MXene Initiated by Metal Ions. Adv. Mater. 2019, 31 (43), 1-7. https://doi.org/10.1002/adma.201902432.
(37) Kubota, S.; Ozaki, S.; Onishi, J.; Kano, K.; Shirai, O. Selectivity on Ion Transport across Bilayer Lipid Membranes in the Presence of Gramicidin A. Anal. Sci. Int. J. Japan Soc. Anal. Chem. 2009, 25 (2), 189-193. https://doi.org/10.2116/analsci.25.189.
(38) Maleski, K.; Shuck, C. E.; Fafarman, A. T.; Gogotsi, Y. The Broad Chromatic Range of Two-Dimensional Transition Metal Carbides. Adv. Opt. Mater. 2021, 9 (4), 1-8. https://doi.org/10.1002/adom.202001563.
(39) Huang, D.; Xie, Y.; Lu, D.; Wang, Z.; Wang, J.; Yu, H.; Zhang, H. Demonstration of a White Laser with V2C MXene-Based Quantum Dots. Adv. Mater. 2019, 31 (24), 1-7. https://doi.org/10.1002/adma.201901117.
(40) Maleski, K.; Ren, C. E.; Zhao, M. Q.; Anasori, B.; Gogotsi, Y. Size-Dependent Physical and Electrochemical Properties of Two-Dimensional MXene Flakes. ACS Appl. Mater. Interfaces 2018, 10 (29), 24491-24498. https://doi.org/10.1021/acsami.8b04662.
Seredych, M.; Shuck, C. E.; Pinto, D.; Alhabeb, M.; Precetti, E.; Deysher, G.; Anasori, B.; Kurra, N.; Gogotsi, Y. High-Temperature Behavior and Surface Chemistry of Carbide MXenes Studied by Thermal Analysis. Chem. Mater. 2019, 31 (9), 3324-3332.

1. A method, comprising:
providing a solution of delaminated MXene material and a first ionic intercalant; and
contacting the solution with a second ionic intercalant so as to exchange the first ionic intercalant and the second ionic intercalant so as to give rise to flocculated portions of the MXene material and a supernatant that comprises the first ionic intercalant and the second ionic intercalant.

2. The method of claim 1, further comprising replacing at least some of the supernatant with a saturated solution of the second ionic intercalant.

3. The method of claim 2, wherein the saturated solution of the second ionic intercalant is a supersaturated solution.

4. The method of claim 1, wherein the first ionic intercalant comprises an organic base, the organic base optionally comprising TMAOH, TBAOH, TEAOH, TPAOH or any combination thereof.

5. The method of claim 1, wherein the second ionic intercalant comprises an alkali cation-containing inorganic salts, the alkali cation-containing inorganic salt optionally comprising LiCl, NaCl, KCl, MgCl₂, CaCl₂, Li₂SO₄, K₂SO₄, MgSO₄, Na₂SO₄, LiOH, NaOH, KOH, or any combination thereof.

6. The method of claim 1, wherein the flocculated portions of MXene material are one or both of single layer MXene or few-layer MXene.

7. The method of claim 1, wherein the MXene has the formula Mₙ₊₁CₙTₓ, wherein M is V.

8. The method of claim 8, wherein the MXene has the formula of V₂CTₓ.

9. The method of claim 1, further comprising redispersing the flocculated MXene portions in solution.

10. The method of claim 9, wherein the flocculated portions of MXene material remain essentially undegraded after storage under ambient conditions for 150 days.

11. A MXene dispersion, comprising:
a plurality of portions of single-layer and/or few-layer MXene dispersed in a solvent, the solvent comprising a first ionic intercalant and a second ionic intercalant.

12. The MXene dispersion of claim 11, wherein the first ionic intercalant comprises TMAOH and/or TBAOH.

13. The MXene dispersion of claim 11, wherein the second ionic intercalant comprises LiCl.

14. The MXene dispersion of claim 11, wherein the MXene has the formula Mₙ₊₁CₙTₓ, wherein M is V.

15. The MXene dispersion of claim 14, wherein the MXene has the formula of V₂CTₓ.

16. A stable MXene dispersion, comprising
a plurality of portions of single-layer and/or few-layer MXene dispersed in a solvent, the solvent comprising an ionic intercalant, the ionic intercalant optionally being present in supersaturated form.

17. The stable MXene dispersion of claim 16, wherein the ionic intercalant comprises LiCl.

18. The stable MXene dispersion of claim 16, wherein the MXene has the formula Mₙ₊₁CₙTₓ, wherein M is V.

19. The stable MXene dispersion of claim 18, wherein the MXene has the formula of V₂CTₓ.

20. The stable MXene dispersion of claim 16, wherein the MXene remains essentially undegraded after storage under ambient conditions for 150 days.
